(19) United States
(12) Patent Application Publication
(10) Pub. No.: US 2003/0218041 A1
(43) Pub. Date: Nov. 27, 2003

(54) Cartridge, in particular for setting tools and device for igniting a propulsive charge for setting tools

(76) Inventors: Tilo Dittrich, Feldkirch (AT); Gerhard Ehmig, Rankweil (AT); Norbert Heeb, Buchs (CH); Jens Neumann, Feldkirch (AT); Thomas Sperrfechter, Zizers GR (CH)

Correspondence Address: DAVID TOREN, ESQ., SIDLEY, AUSTIN, BROWN & WOOD, LLP, 787 SEVENTH AVENUE, NEW YORK, NY, 10019-6018, US

(21) Appl. No.: 10/319,247

(22) Filed: Dec. 13, 2002

(30) Foreign Application Priority Data
Dec. 17, 2001 (DE) 10161933.2

(51) Int. Cl. B25C 1/14

(52) U.S. Cl. 227/10

(57) ABSTRACT

The present invention relates to a cartridge(10), in particular for a setting tool, comprising a sleeve member (11) and a sleeve cover (13), which form the jacket surface (13), and a bottom side (16) and a face side (15). Intended break zones (20) are arranged on the cartridge (10) surface to be opened, wherein the intended break zones are opened by the explosive pressure of a propellant charge (12) situated inside the cartridge (10). For the improvement of such cartridges (10), the intended break zone (20) is formed by weakened zones (21) extending from a center (22, 22′) and therefrom forming the shape of a star. The invention also relates to a device for firing a propellant charge situated within a cartridge, in particular for setting tools. The device comprises a housing with a therein disposed chamber for receiving a cartridge with a propellant charge, a hollow space connected with the chamber by at least one opening, in which a piston is moveably guided and which is translated by the expanding gases of a fired propellant charge from one position in proximity to the chamber to a position distant therefrom. To improve such a device, a spike or conical element can be arranged on the bottom side of the chamber arranged opposite the face side of the cartridge, the tapered end of the spike or cone facing towards the face side of the cartridge and projecting into the inner space of the chamber.

### BACKGROUND OF THE INVENTION

The present invention relates to a cartridge for setting tools comprising a sleeve member and a sleeve cover forming a jacket surface; a bottom side and a face side; and a propellant charge inserted into the sleeve member; wherein at least one intended break zone is disposed at a surface of the cartridge opened by the explosive pressure of the propellant charge. The present invention also relates to a device for firing a propellant charge situated within a cartridge for setting tools, comprising a housing and a chamber disposed therein for receiving the cartridge; a hollow space in contact with the chamber by at least one opening; a piston being slidingly guided in the hollow space and being shifted, by expanding gases of a fired propellant charge, from one position proximate to the chamber to a position distant from the chamber; wherein a conical element is arranged on a bottom surface of the chamber disposed opposite to a face side of the cartridge, a tapered end of the conical element facing the face side and projecting into the inner space of the chamber.

Cartridges of this type are used, for example, in stud setting tools, wherein they are used as the driving means.

It is important for the function of the apparatus to be driven by the cartridges that the cartridges, after ignition, open controllably under the action of the pressure of the expanding reaction gases.

According to EP 0 490 252 B1, upon which the present invention is based, a cartridge is disclosed that encloses a sleeve member made of plastic and which is filled with a propellant charge. The sleeve member is provided on its front end side opposite the ignition wafer with an intentional breaking point, which is not further described, wherein the sleeve member bursts open when the propellant charge associated with it is ignited.

In another cartridge disclosed by EP 0 490 252 B1 the sleeve member is sealed on its end face with a covering foil made of aluminum. With the explosion of the propellant charge, the cartridge opens at this aluminum foil as the point of least resistance.

EP 0 490 252 B1 describes a preferred zone at which the cartridge bursts, at the time of triggering. There is, however, the danger that particles from the burst zones come loose and then lead to disturbances in the device. Furthermore, pieces of the burst bottle of the cartridge can protrude extensively beyond the original expansion of the cartridge, as a result of the explosion, such that, for example, they protrude into the exhaust duct. As a result, transport problems in the magazine strip and loading impairments can occur.

### SUMMARY OF THE INVENTION

The object of the present invention is to develop a cartridge that avoids the above drawbacks. This is achieved a cartridge for setting tools according to the invention comprising a sleeve member and a sleeve cover forming a jacket surface; a bottom side and a face side; and a propellant charge inserted into the sleeve member; wherein at least one intended break zone is disposed at a surface of the cartridge opened by the explosive pressure of the propellant charge.

In accordance with the invention, the breaking point, at which the cartridge bottle to be opened by the explosive pressure of the propellant charge, is a weakened zone expanding from a center. The weakened zones expand, for example, in a star-like shape from the center. In such weakened zones, the material comprising the sleeve member or the sleeve covering is thinned. This thinning can be produced at the time of the injection molding, by which the sleeve member or the sleeve covering is manufactured, or the weakened zones can be applied subsequently by, for example, stamping, cutting, milling on the surface. The weakened zones can, for example, be produced directly at the time of the deep drawing or pressing process for producing the blister. Using this operation, a defined fissure formation occurs at the time of igniting the propellant charge. The fissure prevents pieces of the exploded bottle from flying off and causing problems in the apparatus. Furthermore, the fragments of the bottle project only unsubstantially from the original expansion of the cartridge. The cartridge, according to the invention, thus, provides an error-free actuation of the setting tool driven. According to the invention, the cartridge can also be designed as a blister, in which the opening of the sleeve member has been sealed by at least on foil. It should be further noted at this point that the weakened zones can be disposed both internally and externally on the cartridge or the blister.

The weakened zones are advantageously disposed on the face side of the cartridge or the blister. The face side corresponds to the surface of the cartridge that is opened by the explosive pressure of the propellant charge. The face side of the cartridge generally lies opposite the exhaust channel(s) which run from the combustion chamber to the cylinder or piston cavity of the setting tool to be operated using the cartridge.

It is further advantageous, if the weakened zones are disposed relative to each other in the form of a star having n-rays, wherein the variable n is a whole number in the range of 2 to infinity. The advantage emerging from such an operation is that the intended rupture point can be adapted to the respective predefined geometry of the combustion chamber.

The present patent application further addresses the drawbacks of the device disclosed in EP 0 490 252 B1, wherein a chamber is disposed in a housing and the chamber serves to receive a propellant charge in a cartridge, for example. The chamber is connected with a further cavity, into which a cartridge is moveably inserted, by means of an opening. If the cartridge or the propellant charge explodes, then the piston accelerates from its resting position into a temporary movement by the action of the expanding gases and the piston produces work such as, for example, driving a nail into a substrate.

In such cartridges and propellant charges, an intended breaking point on the face side of the cartridge or the propellant charge is provided but not further defined. In the ignition of the cartridge or propellant charge, however, there is the possibility that the cartridge might not open at the intended breaking point so that a misfire results.

Therefore, it is an object of the invention to provide a for firing a propellant charge, for setting tools, that supports the opening of the cartridge or propellant charge at a predefined position. In accordance with the invention, a spike or conical element is arranged on the bottom surface of the chamber whose end draws out to a tip or a cone apex and is directed towards the face side of the propellant charge. The spike or conical element projects into the chamber (or the chamber hold). A cartridge or propellant charge inserted into the chamber, thus, is situated directly opposite the spike or conical element. The tip of the spike or conical element is approximately disposed opposite the center of the star-shaped weakened zones. If the cartridge is exploded, the tip of the spike or conical element supports the defined opening of the cartridge at the intended break point. Even when using cartridges, without intended break points, on the bottle that is to be opened by the explosion, the spike or conical element on the bottom surface of the chamber effect a satisfactory opening of the opposing face side of the cartridge or the propellant charge.

It is a further advantage of the invention, to provide a bushing member, in the chamber, which assists in receiving the cartridge or the blister. In such an embodiment, the receiving of the cartridge or the blister is effected essentially form-lockingly, whereby the bushing member can be spring loaded using a spring member towards the rear wall of the chamber such that there is a sealing of the chamber prior to firing of the cartridge or blister situated in the chamber.

Preferably, when a sealing means is arranged on the rear wall of the chamber then the sealing of the chamber or the cartridge chamber may also be improved.

### BRIEF DESCRIPTION OF THE DRAWINGS

The various embodiments, additional advantages and processes of the invention are discussed in the detailed description of the invention with reference to the drawings, wherein:

FIG. 1 shows a first embodiment of a cartridge according to the invention in a face side view;

FIG. 2 shows a second embodiment of the cartridge according to the invention in a face side view;

FIG. 3 shows a third embodiment of the cartridge according to the invention in a face side view;

FIG. 4 shows a fourth embodiment of the cartridge according to the invention in a face side view;

FIG. 5 shows a fifth embodiment of the cartridge according to the invention in a face side view;

FIG. 6 shows a sixth embodiment of the cartridge according to the invention in a face side view;

FIG. 7 shows a seventh embodiment of the cartridge according to the invention in a face side view;

FIG. 8 shows an eighth embodiment of the cartridge according to the invention in a face side view;

FIG. 9 shows a section of the embodiment of FIG. 1 along the line IX-IX;

FIG. 10 shows a section of the embodiment of FIG. 1 along the line X-X;

FIG. 11 shows a cross-section of an embodiment of a cartridge according to the invention;

FIG. 12 shows a cross-section of a device for firing propellant charge according to the invention, in a cutout view, representing the cartridge chamber;

FIG. 13 shows a cross-section of a second embodiment of a device for firing propellant charge according to the invention, in a cutout view, representing the cartridge chamber.

### DETAILED DESCRIPTION OF THE EMBODIMENTS

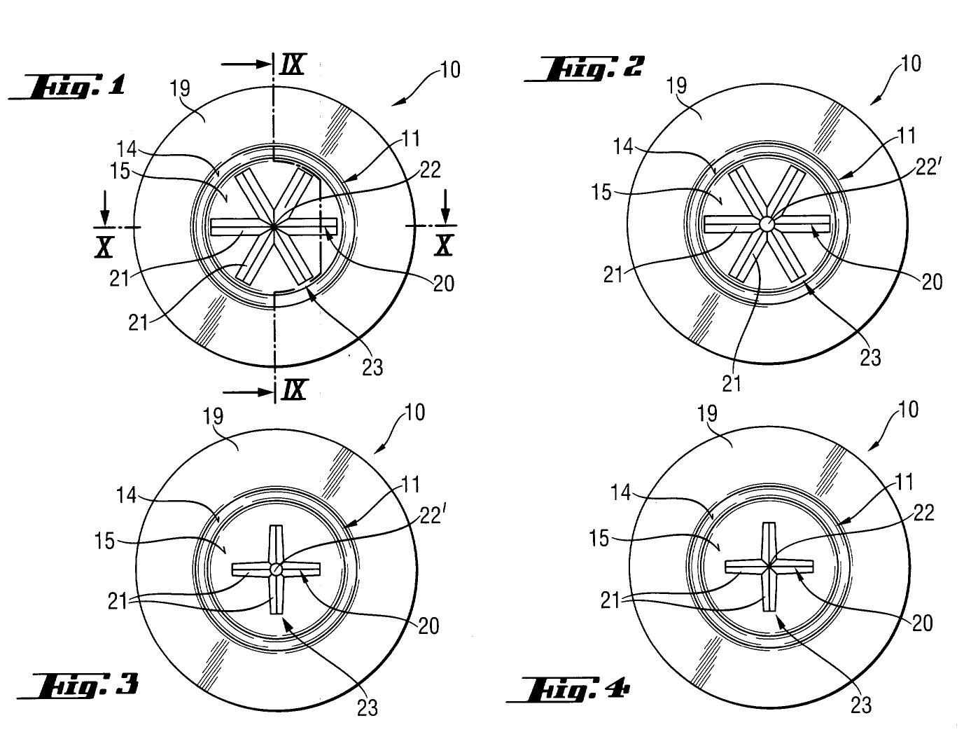

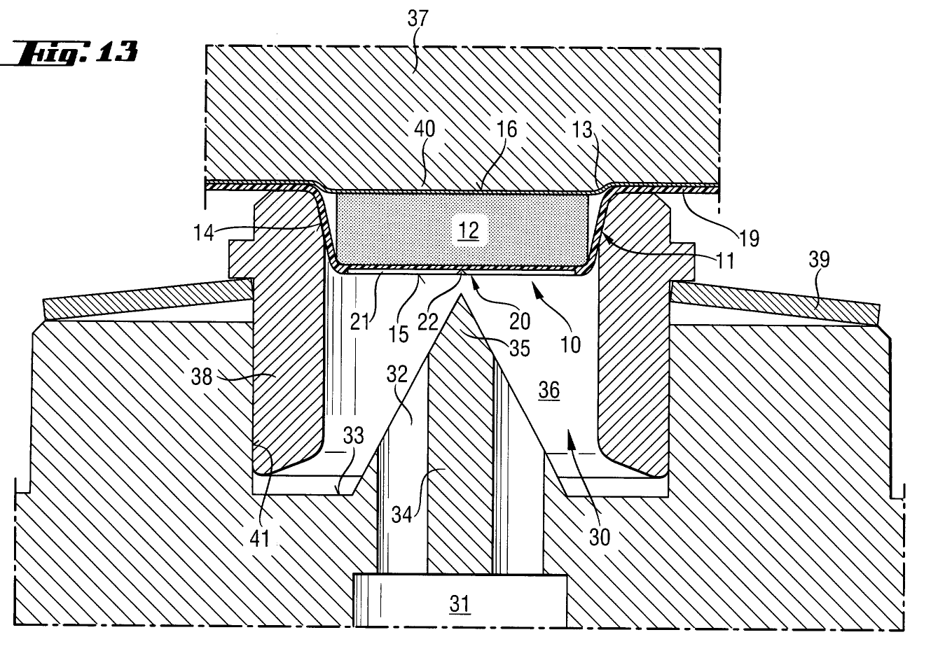

FIGS. 1, 9 and 10 show the first embodiment of cartridge 10. Cartridge 10, which is executed as a blister, comprises a sleeve member 11, in whose inner surface a propellant charge is disposed, and which is provided with a sleeve cover 13, over which the sleeve member 11 is medium-tightly or at least liquid-tightly sealed. In this embodiment, the sleeve member 11 comprises both a jacket surface 14 and a face end 15 of the cartridge 10 or the blister. The sleeve cover, which is shown as covering foil 13, forms the bottom surface 16 of the cartridge 10. An edge zone 19 is arranged at the sleeve body 11, in the bottom surface 16 and over which the cartridge can rest a bushing part 38 of a cartridge chamber 30 (or a chamber) of a setting device, in contact with the edge zones, as shown in FIGS. 12 and 13.

In magazine cartridges 10, the edge zones 19 of the cartridge between adjacent cartridges 10 are connected with each other such that magazine strips are formed. An intended break point 20 is disposed externally on the face side 15 of the sleeve body 11 of the cartridge 10. In the embodiment, the intended break point 20 comprises weakened zones 21 surrounding a center 22, which forms a six-rayed star 23. The weakened zones 21 and the center 22 are produced by wedge-shaped recesses in the surface of the face side 15 of the sleeve member 11. The weakened zones can also be formed by other recesses such as semi-circular depressions, for example.

FIG. 12 shows how a cartridge is inserted into a chamber 30 or into a cartridge chamber of a setting tool, in accordance with the invention. In FIG. 12, the chamber 30 is closed. The bottom surface 16 of the cartridge 10 is approximately flush in contact with a chamber rear wall 37, on which a sealing member is arranged 40, whose external diameter corresponds substantially to the external diameter of the sleeve member 11. The cylindrically formed side wall of the chamber 30 shown in this embodiment is formed by a bushing part 39, which is slidingly disposed in a bushing guide 41 of the device. The bushing guide 41 is pre-stressed by a spring member 39 towards the rear wall 37 of the chamber. The cartridge 10 or the propellant charge 12, arranged in the cartridge, may be exploded by a pull or trigger on the device. When this is done, by way of printed circuits, for example, an ignition spark is transmitted to an ignition element on the cartridge 10 such that the propellant charge 12 explodes. As a result of pressure created by the expanding gases formed at the time of the explosion of the propellant charge 12, the cartridge 10 opens along the weakened points 21, whereby the expanding gases access the inner space 36 of the chamber. With a propagation of the pressure wave, the gases are then forced through the openings or discharge ducts 32 into the hollow space 31, in which a piston is arranged (not represented herein). This piston is set into motion by the expanding gases, thereby performing work.

The chamber 30 or the cartridge chamber is opened by a relative retraction of the chamber wall 37, for example, for removing the cartridge 10 from the cartridge chamber 30. The cartridge 10 is then removable from the cartridge chamber zone by a sliding motion parallel to the rear wall 37 of the chamber. By applying the inventive weakened zones 21 extending from a center, no parts separate from the opened face side 15 of the cartridge 10 and such parts remain in the inner space 26 of the chamber 30. Similarly, the zones of the face side 15, in the proximity of the opened weakened zones 21, do not project so far beyond the original dimensions of the cartridge that they would create an obstruction to transport.

FIG. 2 represents another exemplary embodiment of a cartridge 10 according to the invention. This embodiment differs from the previously described embodiment in that the center 22′ is not punctiform but has a flattened circular shape.

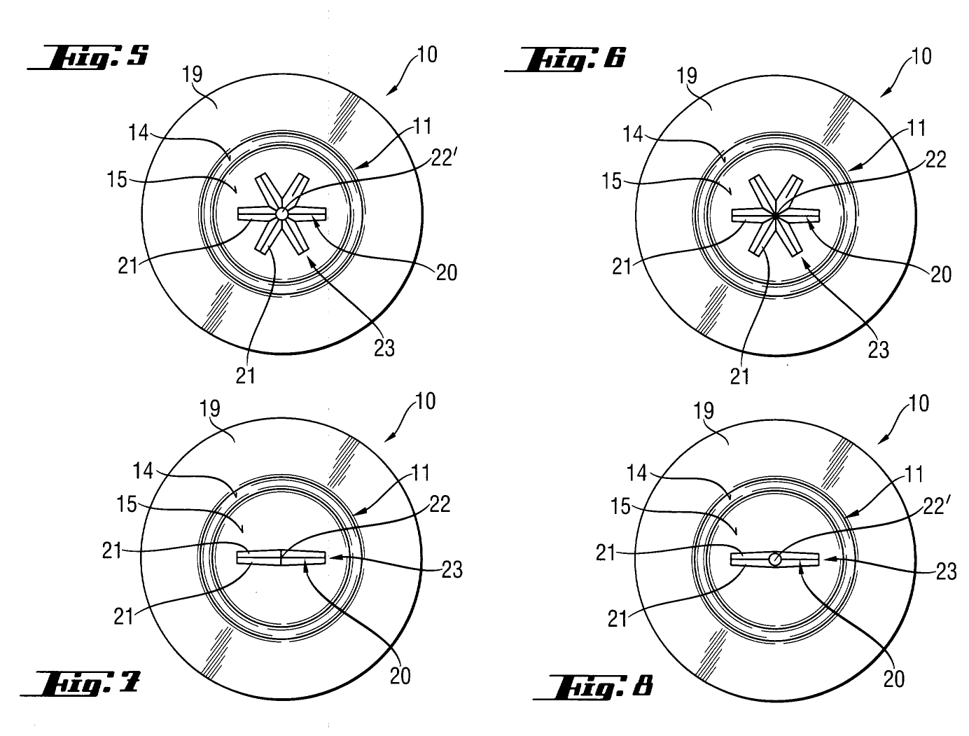

The embodiment of FIG. 3 differs from the embodiment of FIG. 2 in that the weakened zones 21 are arranged as a multi-rayed star 23 and do not extend up to the edge of the face side 15.

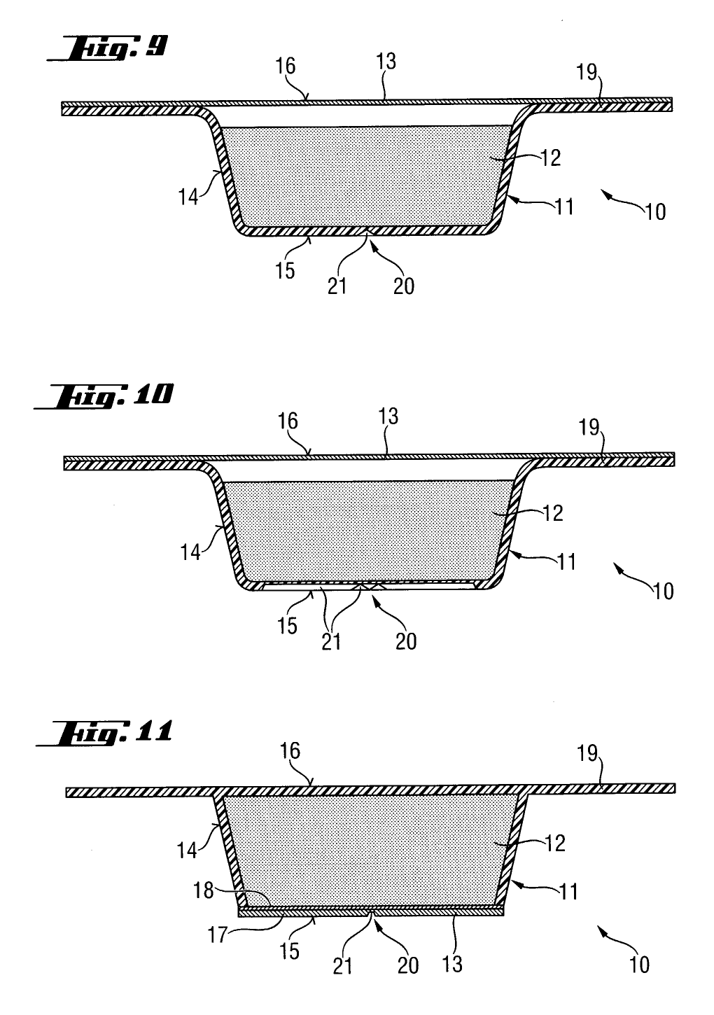

The embodiment of FIG. 4 corresponds substantially to the cartridge 10 of FIG. 3 but exhibits a punctiform center 22.

The embodiment of FIG. 5 differs from the embodiment of FIG. 2 in that the weakened zones 21 are shorter than the weakened zones 21 of FIG. 2 and do not extend to the external edge of the face surface 15.

The embodiment of FIG. 6 differs from FIG. 5 in that the center 22 is punctiform and not flattened.

The embodiment of FIG. 7 differs from the above cartridges in that the weakened zones 21 form a two-rayed star that extends from a punctiform center 22.

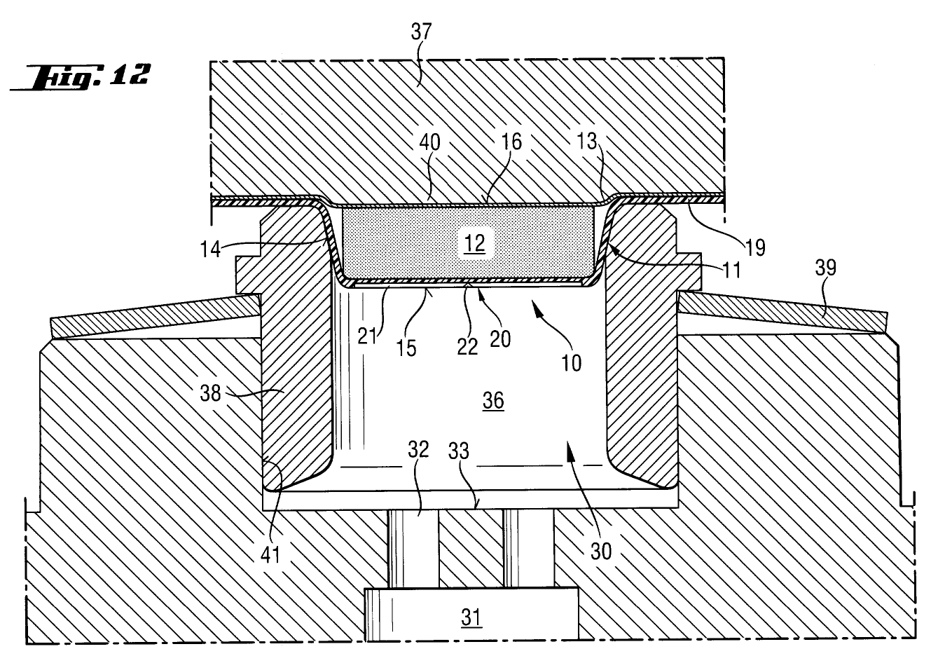

The embodiment of FIG. 8 differs from FIG. 7 in that the center 22′ of the two-rayed star 23 is flattened.

The embodiment of FIG. 11 of a cartridge 10 has an intended break zone 20, on its face side 15, that is formed by weakened zones 21 arranged in a star shape. In this embodiment, the bottom surface 16 and the jacket surface 14 of the cartridge 10 are formed by the sleeve member 11. An edge zone 19 is also integral to this sleeve member 11.

In this embodiment, a cover foil 13 is disposed at the opening of the jacket surface 14 opposite the bottom surface 16. The inner space of the cartridge 10 or the blister, in which the propellant charge 12 is arranged, is sealed tightly to any medium with this cover foil 13. The cover foil 13 comprises a first foil layer 17 and a second foil layer 18. The first externally disposed foil 18 exhibits the weakened zones 21, while the second internally disposed foil 17 does not exhibit weakened zones. The two foils 17, 18 can be glued, welded or bonded to each other by any other means for a better connection. The weakened zones 21 can be arranged on the second foil 17 layer instead of on the first foil 18 layer.

The weakened zones 21 can be arranged in any conceivable fashion on the face side 15 of the cartridge 10 or blister. If the face side is made of plastic the weakened zones can, for example, be produced already in the injection process or at the time the part carrying the face side 15 is produced. The weakened zones 21 can, however, also be produced by subsequent processing, for example, by milling or cutting.

FIG. 13 shows an embodiment, according to the invention, of a device for firing a propellant charge. The chamber 30 of FIG. 13 differs from the chamber 30 of FIG. 12 in that a spike-shaped element 34 is arranged in the inner space 36 of the chamber 30. This spike-shaped element 34 can, as in the previous embodiment, be a pointed cone with a circular base. It can also be another shape, such as for example, a three or multilateral pyramid or a circular cone. Furthermore, the spike-shaped element 34 can have one or a plurality of edges on its flanks that support the defined opening of the weakened zones or the intended break zone. The tapered end 35 of the spike-shaped element 34 is disposed approximately centrally opposite the face side 15 of a cartridge 10 or blister situated in the chamber. If the propellant charge 12 disposed in the cartridge 10 is caused to explode, the opposingly disposed tapered end 35 of the spike-shaped element 34 promotes the defined opening of the face side 15. In this embodiment, the openings or the discharge ducts 32 run through the element 34 into the hollow space 31, in which the piston (not represented herein) is arranged. These openings 32 could, however, also be arranged at another point in the bottom surface 33 of the chamber 30. The spike-shaped element 34 may also occupy a considerably smaller base area on the bottom surface 33 of the chamber 30 than in the cone represented herein.

The embodiments represented herein are meant to merely illustrate the invention and in no way limit the invention.

What is claimed is:

1. A cartridge (10) for setting tools comprising a sleeve member (11) and a sleeve cover (13) forming a jacket surface (14); a bottom side (16) and a face side (15); and a propellant charge (12) being inserted into the sleeve member (13); wherein at least one intended break zone (20) is disposed at a surface of the cartridge (10) opened by the explosive pressure of the propellant charge (12).

2. The cartridge of claim 1, wherein a plurality of weakened zones (21) are arranged on the face side (15).

3. The cartridge of claim 1, wherein the face side (15) is formed by the sleeve cover (11) and the sleeve cover (11) comprises a first foil layer (17) and a second foil layer (18), wherein a plurality of weakened zones (21) are arranged on the first foil layer (17) and the second foil layer (18) is platelike bonded with the first foil layer (17).

4. The cartridge of claim 1, wherein a plurality of weakened zones (21) are arranged on the sleeve member (11).

5. The cartridge of claim 1, wherein the sleeve member (11) is plastic.

6. The cartridge of claim 2, wherein the weakened zones (21) are made by a thinning of the material.

7. The cartridge of claim 2, wherein the weakened zones (21) are arranged as an n-rayed star (23) relative to each other, wherein n is a whole number in the range of 2 to infinity.

8. A device for firing a propellant charge (12) situated within a cartridge (10) for setting tools, comprising a housing and a chamber (30) disposed therein for receiving the cartridge (10); a hollow space (31) in contact with the chamber (30) by at least one opening (32); a piston being slidingly guided in the hollow space and being shifted, by expanding gases of a fired propellant charge (12), from one position proximate to the chamber (30) to a position distant from the chamber (30); wherein a conical element (34) is arranged on a bottom surface (33) of the chamber (30) disposed opposite to a face side (15) of the cartridge (10), a tapered end (35) of the conical element (34) facing the face side (15) and projecting into the inner space of the chamber (30).

9. The device of claim 8, wherein a jacket wall of the chamber (3) is at least partially formed by a bushing part (38) urged by a spring element (39) towards a rear wall (37) of the chamber.

10. The device of claim 9, wherein a sealing means (40) is disposed at the rear wall (37) in an area situated opposite a bottom side (16) of the cartridge (10) and a periphery of the sealing means substantially corresponds to a periphery of a jacket surface (14) of the cartridge (10).
